(19) United States
(12) Patent Application Publication
(10) Pub. No.: US 2006/0197924 A1
(43) Pub. Date: Sep. 7, 2006

(54) Distance adjusting apparatus and optical assembly of a projector having the same

(76) Inventor: Yueh-Jen Chen, Taipei City (TW)

Correspondence Address: RABIN & Berdo, PC, 1101 14TH STREET, NW, SUITE 500, WASHINGTON, DC, 20005, US

(21) Appl. No.: 11/363,284

(22) Filed: Feb. 28, 2006

(30) Foreign Application Priority Data
Mar. 1, 2005 (TW) 94106153

(51) Int. Cl. G03B 21/14

(52) U.S. Cl. 353/101

(57) ABSTRACT

A distance adjusting apparatus is disposed between a first optical module and a second optical module for adjusting the distance between the two optical modules and includes a supporting component, a stroke ring and an elastic component. The supporting component includes a bump. The stroke ring includes a spiral surface. Two ends of the elastic component are respectively connected to the first and the second optical modules. An elastic restoring force generated by the elastic component is applied onto the first and the second optical modules, so that the bump presses the spiral surface. By applying a force onto the stroke ring to rotate the spiral surface, a relative movement occurs between the bump and the spiral surface, so that a relative displacement of the stroke ring moving forward along an axial direction is controlled, and that the distance between the first and the second optical module is adjusted.

This application claims the benefit of Taiwan application Serial No. 94106153, filed Mar. 1, 2005, the subject matter of which is incorporated herein by reference.

### BACKGROUND OF THE INVENTION

1. Field of the Invention

The invention relates in general to a distance adjusting apparatus and an optical assembly of a projector having the same, and more particularly to a distance adjusting apparatus for adjusting the distance between two optical modules by the spiral surface, and an optical assembly of a projector having the same.

2. Description of the Related Art

According to prior art, the optical assembly of a projector adjusts the distance between the components by locking paired screw tooth and screw thread with the components inside the optical assembly. The distance between the components inside the optical assembly has much to do with the size of illuminant region formed when the ray of light passes through the optical assembly to be projected onto the imaging component. If the illuminant region is not large enough to cover up the imaging component, the images projected by the projector would be truncated. Therefore, it is crucial to adjust the distance between the components inside the optical assembly.

Due to the fact that specifications of the screw tooth and screw thread of conventional optical assembly are specific and the requirement that the tolerances of the screw tooth and the screw thread need to fit with the optical assembly, the manufacturers are facing lots of difficulties in manufacturing the screw tooth and the screw thread. Furthermore, the structures of the screw tooth and the screw thread are rather complicated and are hard to inspect. Moreover, if the screw tooth and the screw thread are screwed too tight, the screw tooth and the screw thread will easily get stuck and make the adjustment difficult during assembly. Besides, the pre-locking position of conventional screw tooth and screw thread changes quite often, affecting the controllable displacement and reducing the room of adjustment of the components inside the optical assembly, so that the completeness of the image projected by the projector is impaired.

### SUMMARY OF THE INVENTION

It is therefore an object of the invention to provide a distance adjusting apparatus and an optical assembly of a projector having the same. By rotating the spiral surface of the stroke ring to press against the bump of the supporting component, the displacement of the stroke ring along an axial direction is controlled. The distance adjusting apparatus of the invention uses the spiral surface to replace the complicated structure of conventional screw tooth and screw thread, not only simplifying the process of distance adjustment, but also making manufacturing and inspection process easier.

The invention achieves the above-identified object by providing a distance adjusting apparatus disposed between a first optical module and a second optical module for adjusting the distance between the first optical module and the second optical module. The distance adjusting apparatus includes a supporting component, a stroke ring and an elastic component. The supporting component disposed on the first optical module includes at least a bump. The stroke ring rotatably disposed between the supporting component and the second optical module includes at least a spiral surface. Two ends of the elastic component are respectively connected to the first optical module and the second optical module. An elastic restoring force generated by the elastic component is applied onto the first optical module and the second optical module, so that the bump presses against the spiral surface. By applying a force onto the stroke ring to rotate the spiral surface, a relative movement occurs between the bump and the spiral surface, so that a relative displacement of the stroke ring moving forward along an axial direction is controlled, and that the distance between the first optical module and the second optical module is adjusted.

The invention achieves the above-identified object by further providing an optical assembly of the projector including at least a light pipe module, a lens module and a distance adjusting apparatus. The distance adjusting apparatus is disposed between the light pipe module and the lens module for adjusting the distance between the light pipe module and the lens module. The distance adjusting apparatus includes a supporting component, a stroke ring and an elastic component. The supporting component disposed on the light pipe module includes at least a bump. The stroke ring rotatably disposed between the supporting component and the lens module includes at least a spiral surface. Two ends of the elastic component are respectively connected to the light pipe module and the lens module. An elastic restoring force generated by the elastic component is applied onto the light pipe module and the lens module, so that the bump presses against the spiral surface. By applying a force onto the stroke ring to rotate the spiral surface, a relative movement occurs between the bump and the spiral surface, so that a relative displacement of the stroke ring along an axial direction is controlled, and that the distance between the light pipe module and the lens module is adjusted.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is an exploded view of an optical assembly of a projector according to a preferred embodiment of the invention;

FIG. 2A is a top view of a supporting component and a light pipe module in FIG. 1;

FIG. 2B is a perspective view of a stroke ring in FIG. 1;

FIG. 3A˜FIG. 3C are movement flowcharts of a stroke ring and a portion of the supporting component in FIG. 1;

FIG. 4 is a perspective view of the optical assembly in FIG. 1; and

FIG. 5 is a diagram showing the use of the optical assembly of the projector according to the preferred embodiment of the invention.

### DETAILED DESCRIPTION OF THE INVENTION

The distance adjusting apparatus according to the invention is disposed between the first optical module and the second optical module for adjusting the distance between the first optical module and the second optical module. The invention is exemplified by disposing the distance adjusting apparatus in an optical assembly of a projector. However, anyone who is skilled in the technology of the invention will understand that the scope of protection of the invention is not limited thereto and that the embodiment of the invention is merely an example under the spirit of the invention.

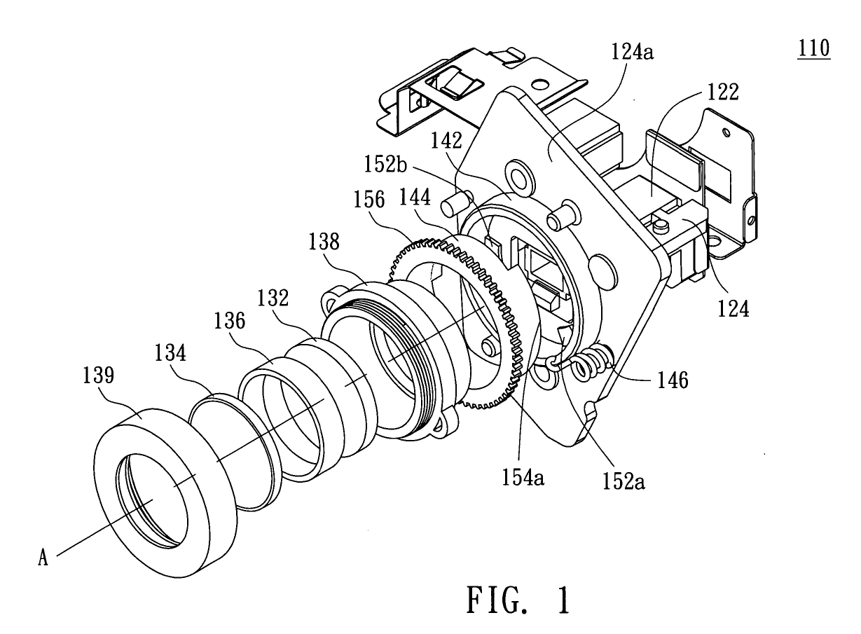

Referring to FIG. 1, an exploded view of an optical assembly of a projector according to a preferred embodiment of the invention is shown. Optical assembly of the projector 110 includes a light pipe module, a lens module and a distance adjusting apparatus. The light pipe module may include a light pipe 122 and a light pipe receiving apparatus 124 for instance. The light pipe 122 enables the uniformity of the ray of light. The light pipe receiving apparatus 124 is for receiving the light pipe 122, and the light pipe receiving apparatus 124 may have a supporting plate 124a for instance.

The lens module used for focusing the ray of light may include a spherical mirror 132 and a non-spherical mirror 134. The spherical mirror 132 and the non-spherical mirror 134 adjacently disposed are preferably inter-spaced by a spacer 136. The spherical mirror 132, the spacer 136 and the non-spherical mirror 134 may be disposed between a mounting ring 138 and a ring lid 139, so that the spherical mirror 132, the spacer 136 and the non-spherical mirror 134 are fixed between the mounting ring 138 and the ring lid 139 after assembly.

The distance adjusting apparatus is disposed between the light pipe module and the lens module for adjusting the distance between the light pipe module and the lens module. The distance adjusting apparatus includes a supporting component, a stroke ring 144 and an elastic component 146. The supporting component includes at least a bump 152a, which is disposed on the light pipe module. The stroke ring 144 includes at least a spiral surface 154a which is rotatably disposed between the supporting component and the lens module. Two ends of the elastic component 146 are respectively connected to the light pipe module and the lens module. One end of the elastic component 146 may be connected to the supporting plate 124a of the light pipe receiving apparatus 124, while another end may be connected to the mounting ring 138 of the lens module for instance. The elastic component 146 may be a spring for instance. An elastic restoring force generated by the elastic component 146 is applied onto the light pipe module and the lens module, so that the bump 152a presses against the spiral surface 154a.

According to the present embodiment, the supporting component preferably further includes a supporting ring 142 which is disposed on the supporting plate 124a of the light pipe receiving apparatus 124. The stroke ring 144 is mounted between the supporting ring 142 and the mounting ring 138. Being retained by the supporting ring 142 and the mounting ring 138, the stroke ring 144 is rotatably disposed between the supporting component and the lens module. Besides, the stroke ring 144 preferably further includes a toothed ring 156. The toothed ring 156 may be disposed on the outer ring of the stroke ring 144.

When the toothed ring 156 is driven by a gear set or manual operation, the spiral surface 154a of the stroke ring 144 is rotated correspondingly. Meanwhile, the bump 152a and the spiral surface 154a a relative movement occurs between, so that a relative displacement of the stroke ring 144 moving forward along axial direction A is controlled, and that the distance between the light pipe module and the lens module is adjusted.

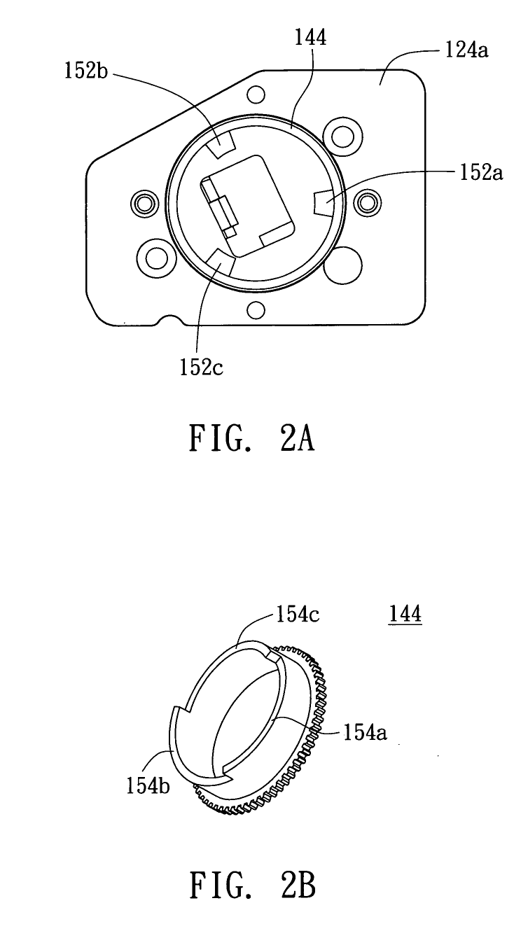

Referring to FIG. 2A, a top view of a supporting component and a light pipe module in FIG. 1 is shown. In addition to the bump 152a, the supporting component further includes a bump 152b and a bump 152c respectively disposed on the supporting plate 124a of the light pipe receiving apparatus. FIG. 2B is a perspective view of the stroke ring 144 in FIG. 1. Referring to both FIG. 2A and FIG. 2B at the same time, the number of spiral surfaces of the stroke ring matches with the number of bumps of the supporting component. Since the supporting component of the present embodiment includes three bumps, the stroke ring 144 of the present embodiment preferably further includes a spiral surface 154b and a spiral surface 154c in addition to the spiral surface 154a. The three spiral surfaces connected sequentially for pressing against the bump 152a, the bump 152b and the bump 152c respectively.

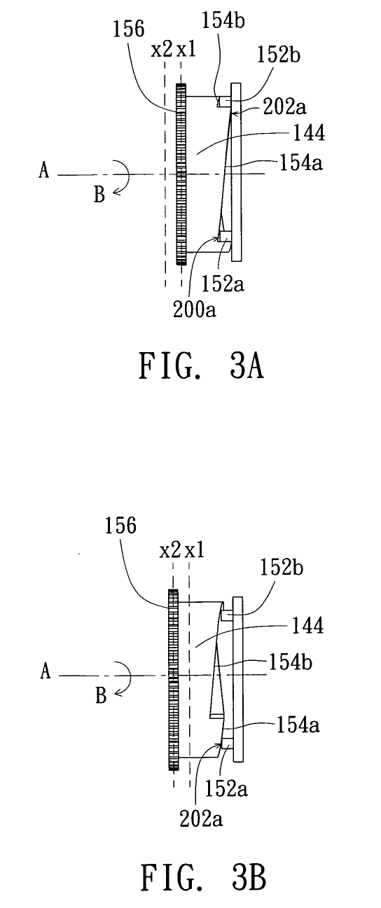

Referring to FIG. 3A˜FIG. 3C, movement flowcharts of a stroke ring 144 and a portion of the supporting component in FIG. 1 are shown. As shown in FIG. 3A, each spiral surface has a bottom and a top. When the bottom 200a of the spiral surface 154a presses against the bump 152a, the stroke ring 144 is positioned at an initial position x1. When a force rotates the stroke ring 144, so that the spiral surface 154a rotates towards a direction B along an axial direction A, the stroke ring 144 changes from the state of pressing against the bump 152a by the bottom 200a of the spiral surface 154a to the state of pressing against the bump 152a by the top 202a of the spiral surface 154a as shown in FIG. 3B. Meanwhile, the stroke ring 144 moves along the axial direction A from an initial position x1 to an extension position x2. Referring to FIG. 3C, when the force continues to rotate the stroke ring 144, so that the spiral surface 154a continues to rotates towards the direction B along the axial direction A, the stroke ring 144 changes from the state of pressing against the bump 152a by the top 202a of the spiral surface 154a to the state of pressing against the bump 152a by the bottom 200b of the spiral surface 154b. Meanwhile, the elastic restoring force of the elastic component restores the stroke ring 144 to the initial position x1 from the extension position x2.

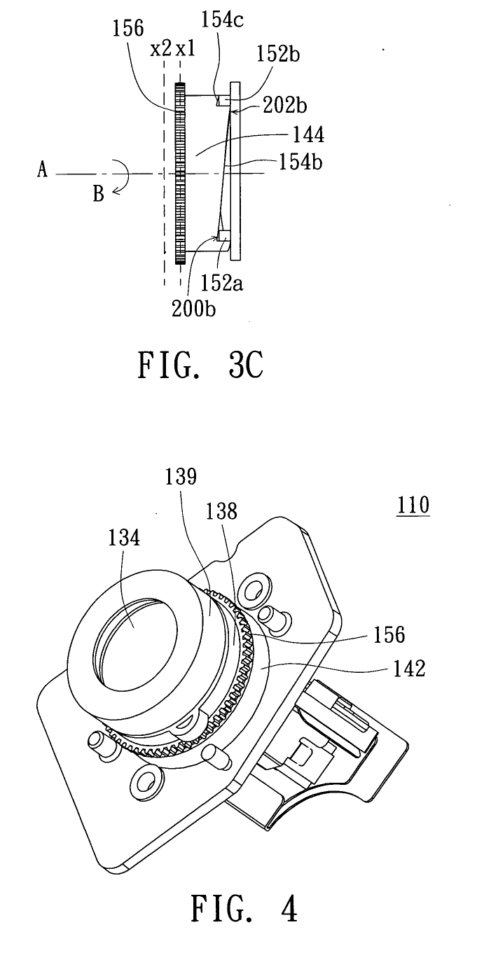

Referring to FIG. 4, a perspective view of the optical assembly 110 in FIG. 1 is shown. After the assembly of the optical assembly 110 is completed, the spherical mirror 132, the spacer 136 and the non-spherical mirror 134 are fixed between the mounting ring 138 and the ring lid 139. The stroke ring 144 is mounted between the mounting ring 138 and the supporting ring 142, while the toothed ring 156 is exposed outside.

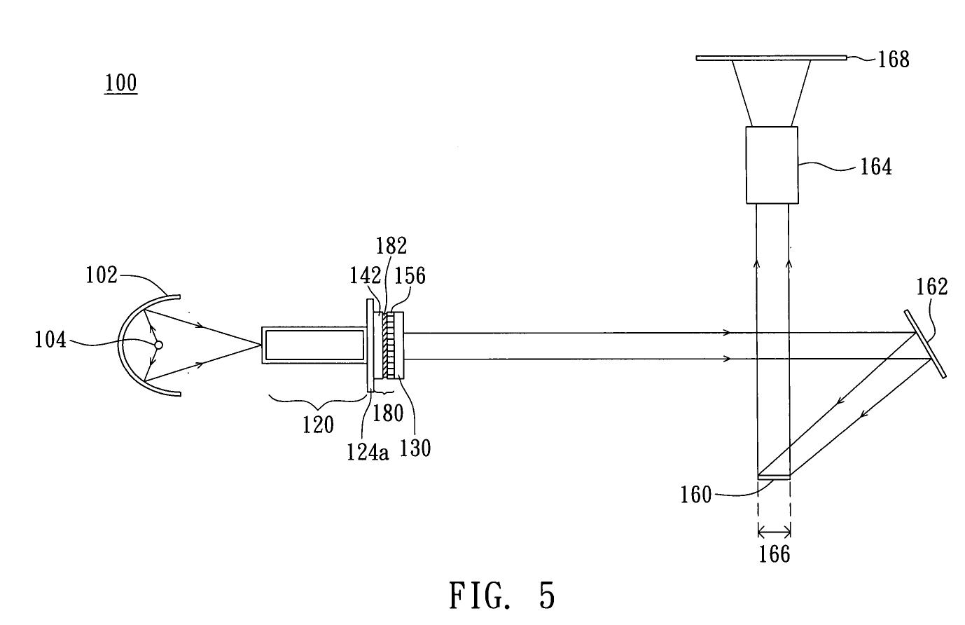

Referring to FIG. 5, a diagram showing the use of the optical assembly of the projector according to the preferred embodiment of the invention is shown. In the present embodiment, the distance adjusting apparatus 180 is disposed in the optical assembly of the projector 100. The projector 100 may include a light source reflector 102, a light source 104, an optical assembly, a reflector 162, an imaging component 160 and a camera lens 164. The light source reflector 102 is disposed on one side of the light source 104 for reflecting the ray of light generated by the light source 104. The optical assembly includes a light pipe module 120, a lens module 130 and a distance adjusting apparatus 180. The imaging component 160 may be digital micro-mirror device (DMD) for instance.

The ray of light generated by the light source 104, after sequentially passing through the light pipe module 120, the distance adjusting apparatus 180 and the lens module 130, is reflected to the imaging component 160 by the reflector 162. The imaging component 160 further reflects the ray of light to the camera lens 164, whence the reflected light is projected to form an image on the screen 168.

The distance between the light pipe module 120 and the lens module 130 may be adjusted by adjusting the distance adjusting apparatus 180 to adjust the size of the illuminant region 166 formed when the ray of light is projected onto the imaging component 160. The illuminant region 166 has to entirely cover up the imaging component 160 in order to ensure the completeness of the image projected by the projector 100. After the area of the illuminant region 166 is substantially the same with that of the imaging component 160 by rotating the spiral surface of the distance adjusting apparatus 180, the glue 182 is filled between the stroke ring and the supporting component of the distance adjusting apparatus 180. For example, the glue 182 is filled between the toothed ring 156 and the supporting ring 142 so that the stroke ring 144 is mounted on the supporting component to fix the distance between the light pipe module 120 and the lens module 130.

The distance adjusting apparatus disclosed in the present embodiment presses against the spiral surface of the stroke ring by the bump of the supporting component to adjust the distance between two optical modules. The user may adjust the distance by rotating the stroke ring only, which is very convenient. By applying the distance adjusting apparatus of the present embodiment to the optical module of projector, the problem arising due to the complicated structure of conventional screw tooth and screw thread can be resolved. With the simple structure of the spiral surface, the manufacturing of the distance adjusting apparatus of the present embodiment is made easier. Whether the distance adjusting apparatus meets the standards or not may be determined by inspecting the slope of the spiral surface. Moreover, when the distance adjusting apparatus of the present embodiment is used to adjust the distance between the light pipe module and the lens module, the conventional problem of having poor tightness between the screw tooth and the screw thread is resolved, increasing the yielding rate of projector during the manufacturing process. Besides, the distance adjusting apparatus of the present embodiment is applicable to projectors of various specifications, enhancing the augmentation of the projector.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A distance adjusting apparatus disposed between a first optical module and a second optical module, wherein the distance adjusting apparatus is for adjusting a distance between the first optical module and the second optical module, and the distance adjusting apparatus comprises:
a supporting component disposed on the first optical module, wherein the supporting component comprises a bump;
a stroke ring rotatably disposed between the supporting component and the second optical module, wherein the stroke ring comprises a spiral surface; and
an elastic component whose two ends are respectively connected to the first optical module and the second optical module, wherein an elastic restoring force generated by the elastic component is applied onto the first optical module and the second optical module, so that the bump presses against the spiral surface;
wherein by applying a force onto the stroke ring to rotate the spiral surface, a relative movement occurs between the bump and the spiral surface, so that a relative displacement of the stroke ring moving forward along an axial direction is controlled, and that the distance between the first optical module and the second optical module is adjusted.

2. The apparatus according to claim 1, wherein the spiral surface has a bottom and a top, wherein when the bottom of the spiral surface presses against the bump, the stroke ring is positioned at an initial position, and wherein when the force rotates the spiral surface so that the top of the spiral surface presses against the bump, the stroke ring moves to an extension position along the axial direction of the stroke ring.

3. The apparatus according to claim 2, wherein when the force rotates the spiral surface so that the spiral surface changes from the state of pressing against the bump by the top to the state of pressing against the bump by the bottom, the elastic restoring force restores the stroke ring to the initial position from the extension position.

4. The apparatus according to claim 1, wherein the stroke ring further comprises a toothed ring, and the spiral surface is rotated correspondingly when the toothed ring is rotated.

5. The apparatus according to claim 1, wherein the supporting component comprises three bumps, and the stroke ring comprises three spiral surfaces connected sequentially for pressing against the three bumps respectively.

6. An optical assembly of a projector, comprising:
a light pipe module;
a lens module; and
a distance adjusting apparatus disposed between the light pipe module and the lens module, wherein the distance adjusting apparatus is for adjusting a distance between the light pipe module and the lens module, and the distance adjusting apparatus comprises:
a supporting component disposed on the light pipe module, wherein the supporting component comprising a bump;
a stroke ring rotatably disposed between the supporting component and the lens module, wherein the stroke ring comprising a spiral surface; and
an elastic component whose two ends are respectively connected to the light pipe module and the lens module, wherein an elastic restoring force generated by the elastic component is applied onto he light pipe module and the lens module so that the bump presses against the spiral surface;
wherein by applying a force onto the stroke ring to rotate the spiral surface, a relative movement occurs between the bump and the spiral surface, so that a relative displacement of the stroke ring along an axial direction is controlled, and that the distance between the light pipe module and the lens module is adjusted.

7. The optical assembly according to claim 6, wherein the spiral surface has a bottom and a top, wherein when the bottom of the spiral surface presses against the bump, the stroke ring is positioned at an initial position, and wherein when the force rotates the spiral surface so that the top of the spiral surface presses against the bump, the stroke ring moves to an extension position along the axial direction of the stroke ring.

8. The optical assembly according to claim 7, wherein when the force rotates the spiral surface so that the spiral surface changes from the state of pressing against the bump by the top to the state of pressing against the bump by the bottom, the elastic restoring force restores the stroke ring to the initial position from the extension position.

9. The optical assembly according to claim 6, wherein the stroke ring further comprising a toothed ring, and the spiral surface is rotated correspondingly when the toothed ring is rotated.

10. The optical assembly according to claim 6, wherein the elastic component is a spring.

11. The optical assembly according to claim 6, wherein the supporting component comprising three bumps, and the stroke ring comprising three spiral surfaces connected sequentially for pressing against the three bumps respectively.

12. The optical assembly according to claim 6, wherein the lens module comprising a spherical mirror and a non-spherical mirror, and the spherical mirror and the non-spherical mirror are adjacently disposed.

13. The optical assembly according to claim 6, wherein the projector further comprising an imaging component, and a ray of light is projected onto the imaging component after passing through the light pipe module and the lens module, wherein by adjusting the distance between the light pipe module and the lens module, a size of an illuminant region formed when the ray of light is projected onto the imaging component is adjusted.

14. The optical assembly according to claim 13 further comprising a glue, wherein after an area of the illuminant region is substantially the same with an area of the imaging component by rotating the spiral surface, the glue is filled between the stroke ring and the supporting component to fix the distance between the light pipe module and the lens module.

15. A projector, comprising:
a first optical module;
a second optical module; and
a distance adjusting apparatus disposed between the first optical module and the second optical module, wherein the distance adjusting apparatus is for adjusting a distance between the first optical module and the second optical module, and the distance adjusting apparatus comprises:
a supporting component disposed on the first optical module, wherein the supporting component comprises a bump;
a stroke ring rotatably disposed between the supporting component and the second optical module, wherein the stroke ring comprises a spiral surface; and
an elastic component whose two ends are respectively connected to the first optical module and the second optical module, wherein an elastic restoring force generated by the elastic component is applied onto the first optical module and the second optical module, so that the bump presses against the spiral surface;
wherein by applying a force onto the stroke ring to rotate the spiral surface, a relative movement occurs between the bump and the spiral surface, so that a relative displacement of the stroke ring moving forward along an axial direction is controlled, and that the distance between the first optical module and the second optical module is adjusted.

16. The apparatus according to claim 15, wherein the spiral surface has a bottom and a top, wherein when the bottom of the spiral surface presses against the bump, the stroke ring is positioned at an initial position, and wherein when the force rotates the spiral surface so that the top of the spiral surface presses against the bump, the stroke ring moves to an extension position along the axial direction of the stroke ring.

17. The apparatus according to claim 16, wherein when the force rotates the spiral surface so that the spiral surface changes from the state of pressing against the bump by the top to the state of pressing against the bump by the bottom, the elastic restoring force restores the stroke ring to the initial position from the extension position.

18. The apparatus according to claim 15, wherein the stroke ring further comprises a toothed ring, and the spiral surface is rotated correspondingly when the toothed ring is rotated.

19. The apparatus according to claim 15, wherein the elastic component is a spring.

20. The apparatus according to claim 15, wherein the supporting component comprises three bumps, the stroke ring comprises three spiral surfaces connected sequentially for pressing against the three bumps respectively.
